(19) United States
(12) Patent Application Publication
(10) Pub. No.: US 2003/0131059 A1
(43) Pub. Date: Jul. 10, 2003

(54) Method, system, and program for providing information on scheduled events to wireless devices

(75) Inventors: Michael Wayne Brown, Georgetown, TX (US); Rabindranath Dutta, Austin, TX (US); Michael A. Paolini, Austin, TX (US)

Correspondence Address: David Victor, Esq, 315 South Beverly Dr., Ste. 210, Beverly Hills, CA, 90212, US

(73) Assignee: International Business Machines Corporation, Armonk, NY

(21) Appl. No.: 10/042,049

(22) Filed: Jan. 8, 2002

(51) Int. Cl. G06F 15/16

(52) U.S. Cl. 709/206

(57) ABSTRACT

Provided is a method, system, and program implemented by a wireless device to provide information on a scheduled event to a calendar database. The wireless devices receives a code and transmits the received code to a server including a calendar database for the user of the transmitting wireless device including scheduled event records. The wireless device receives from the server a scheduled event record including information on one scheduled event associated with the code and renders calendar information at the wireless device including information on the scheduled event included in the scheduled event record.

### BACKGROUND OF THE INVENTION

1. Field of the Invention

The present invention relates to a method, system, and program for providing personal preference information when scheduling events.

2. Description of the Related Art

Portable computing devices, such as hand held computers, cellular phones, palm devices, etc., have become increasingly popular in recent years. The technology has advanced to such a degree that now people can access the Internet through wireless technology, such as a cellular phone or personal digital assistant (PDA), and review content especially tailored for a small portable device. The term PDA, as used herein, refers to any wireless, portable, and small hand held computer device, such as a palm computer, cellular phone, wearable computers, etc. Some of the most popular mobile applications for such wireless devices have included personal information managers (PIMs), entertainment programs, financial services, and mobile commerce.

One of the recent technological developments for mobile Internet access is the Wireless Application Protocol (WAP), which allows mobile devices to use data services and access the Internet. WAP provides a client/server architecture. A WAP enabled client, such as a cell phone or palm computer, can use micro browsers which are designed to operate within the small display screen of mobile devices and use less memory than a desktop browser. Content for mobile WAP enabled devices may be written in the Wireless Markup Language (WML), which provides a tagged mark-up language similar to the hypertext markup language (HTML), but designed specifically to function in a small-screen environment. Many content providers are providing WAP pages to enable access to the large base of mobile phone and PDA users.

Notwithstanding, recent developments in wireless computing, such as more advanced PIMs, Internet browsing and e-commerce features, only provide users with a significantly limited version of the programs and functions that are available at a desktop computer. For instance, a desktop PIM or calendar program provides a substantially more robust display presentation and range of program functionality than is available for mobile wireless device PIM applications. The same is true for Internet browsing. Given the substantial advantages of desktop PIM and Internet access programs over those available for mobile devices, most computer users, except the submarket of frequent business travelers, may not be motivated to purchase wireless devices for uses other than as a mobile telephone and limited PIM, e.g., address book, calendar, to do list, etc.

Thus, there is a need in the art for an application that would more fully exploit wireless computing technology to extend the utility beyond that of a portable telephone and limited PIM.

### SUMMARY OF THE PREFERRED EMBODIMENTS

Provided is a method, system, and program implemented by a wireless device to provide information on a scheduled event in a personal information manager (PIM) application. The wireless devices receives a code and transmits the received code to a server including a calendar database having scheduled event records for the user of the transmitting wireless device. The wireless device receives from the server a scheduled event record including information on one scheduled event associated with the code and renders calendar information at the wireless device including information on the scheduled event included in the scheduled event record.

Further provided is a method system and program implemented by a server to provide scheduled events for users of wireless devices, wherein the wireless devices are capable of displaying calendar information on scheduled events from the scheduled event records. The server receives a code transmitted from the wireless device and determines a scheduled event record corresponding to the received code. The determined scheduled event record is transmitted to the wireless device that transmitted the code, wherein the wireless device is capable of rendering calendar information including information on the scheduled event included in the transmitted scheduled event record.

Still further provided is a method, system, and program method implemented by a wireless device to provide information on a scheduled event in a personal information manager (PIM) application. The wireless device receives a scheduled event record including information on a scheduled event transmitted from a transmitter system including at least one scheduled event record when the wireless device is within a broadcast range of the transmitter system. Calendar information is rendered at the wireless device including information on the scheduled event included in the scheduled event record. The scheduled event record is transmitted to a server including a calendar database for the user of the transmitting wireless device including scheduled event records, wherein the server stores the transmitted scheduled event record with the calendar database records for the user of the wireless device.

Yet further provided is a method, system, and program implemented by a transmitter for transmitting information on scheduled events. The transmitter provides information on at least one scheduled event record, wherein each scheduled event record includes information on a scheduled event. The at least one scheduled event record is transmitted to wireless devices within a broadcast range of the location transmitter, wherein the wireless device adds the scheduled event record to calendar information for the wireless device user.

The described implementations provide methodologies for providing information on scheduled events to a wireless device in the form of scheduled event records that inform the user of the wireless device of a scheduled event. Further, the described implementations provide techniques for enabling event promoters to make scheduled event records including information on events offered by the event promoter to wireless device users. Still further, the scheduled event records provide information that may be rendered with user calendar information at the wireless device.

### BRIEF DESCRIPTION OF THE DRAWINGS

Referring now to the drawings in which like reference numbers represents corresponding parts throughout:

FIG. 1 illustrates a telecommunication environment in which aspects of the invention are implemented;

FIG. 2 illustrates components of a PIM database in accordance with implementations of the present invention;

FIGS. 3a, b, c, d illustrate data structures used in accordance with implementations of the present invention;

FIG. 4 illustrates further details of the telecommunication environment in which aspects of the invention are implemented;

FIGS. 5, 6, and 7 illustrate flowcharts of code logic to gather, process, and use location information in accordance with implementations of the present invention; and

FIGS. 8, 9a, and 9b illustrate examples of a display of user calendar and generated location information in accordance with implementations of the present invention.

FIG. 10 illustrates a telecommunication environment in which aspects of the invention are implemented;

FIG. 11 illustrates logic implemented in the telecommunication environment of FIG. 10 to provide information on scheduled events to wireless devices in accordance with implementations of the invention;

FIG. 12 illustrates an example of how information for shadowed scheduled event records may be displayed in a calendar view in accordance with implementations of the invention;

FIG. 13 illustrates an additional telecommunication environment in which aspects of the invention are implemented; and

FIG. 14 illustrates logic implemented in the telecommunication environment of FIG. 13 to provide information on scheduled events to wireless devices in accordance with implementations of the invention.

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

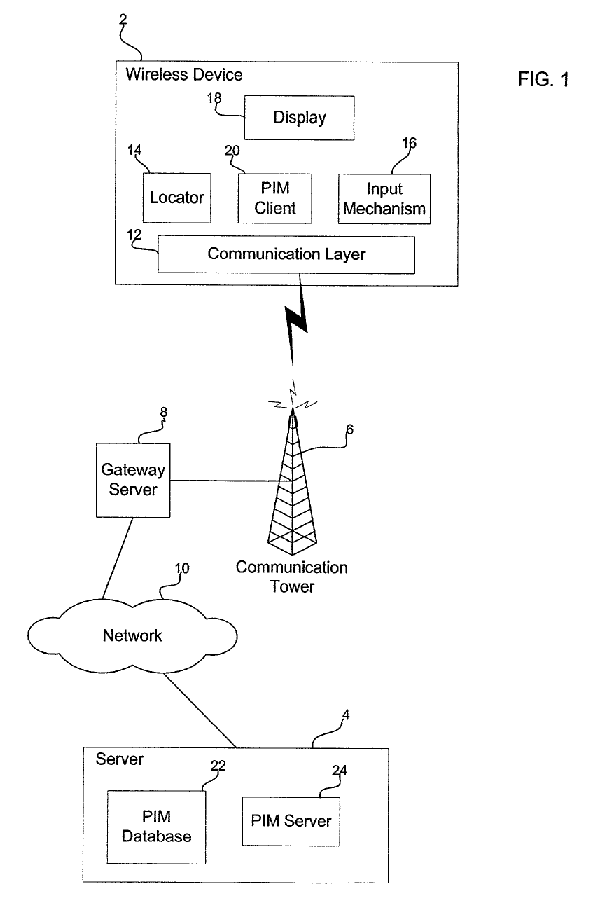

FIG. 1 illustrates a wireless computing environment in which embodiments of the invention are implemented. A wireless device 2, such as a telephony device, e.g., cellular phone, personal digital assistant (PDA), hand held computer, palm computer, etc., communicates with a server 4 via a communication tower 6, gateway server 8, and network 10. The server 4 may comprise one or more server class machines known in the art. The wireless device 2 includes a communication layer 12 which converts digital data into a signal that is transmitted to the communication tower 6 in a manner known in the art. The gateway server 8 converts the signals back into digital data to transmit via network 10 to the server 4. The network 10 may comprise any collection of devices, routers, etc. used to transmit data to a centralized server 4 providing data management for the wireless device 2 operations. The communication tower 6 and communication layer 12 may implement any known wireless transmission technology known in the art, such as 3G, Code-Division Multiple Access (CDMA), Global System for Mobile Communications (GSM), satellite, Bluetooth, etc.** **Bluetooth is a trademark of Telefonaktiebolaget LM Ericsson.

The wireless device 2 further includes locator technology 14 that provides a current position coordinate of the wireless device 2 in three dimensional space (x, y, z) on the surface of the earth and the time the position coordinate was generated. The locator 14 may comprise a global position satellite (GPS) receiver that is capable of calculating a current position based upon signals sent from satellites in a manner known in the art. Alternatively, the location of the wireless device 2 can be estimated externally from the wireless device by measuring the transmissions from the wireless device 2 using any known location positioning technology in a manner known in the art, such as Enhanced Observed Time Differential (E-OTD), Time Of Arrival (TOA), the CellPoint positioning system, the Ericsson Mobile Positioning System, etc.** In fact the United States Federal Communication Commission (FCC) mandated that cellular phone manufacturers incorporate technology to allow the location of the wireless device 2 to be determined. Any reference to the locator 14 refers to the locator technology used within the wireless device 2 that enables a position determination. For instance, if the locator 14 comprises a GPS receiver, then the locator 14 itself may determine the actual position coordinate. Alternatively, the locator 14 may provide information to an external component to enable the external component to determine the position coordinate of the wireless device 2. **Bluetooth is a trademark of Telefonaktiebolaget LM Ericsson.

The wireless device 2 further includes an input mechanism 16 for entering any type of data, including text, voice data, audio, images, movies, etc. The input mechanism 16 may include any known data input system known in the art, including a keyboard embedded in the device 2 with depressable keys, a touch sensitive displayed keyboard, a microphone for providing audio input, voice recognition software, still image camera, video recorder, pen-stylus text input system including handwriting recognition software, etc. Data entered by the user through the input mechanism 16 or downloaded from the server 4 can be rendered in display 18, which may comprise any electronic display device known in the art. A Personal Information Manager (PIM) client 20 gathers and presents PIM information, such as calendering and scheduling information, in accordance with the described implementations. The term “PIM” as used herein refers to a program designed to allow users to organize random bits of information in a useful format. The PIM program may enable calendar or scheduler operations. A calendar program enables one or more users to record and organize events and appointments. A scheduler program enables a group of colleagues to schedule meetings and other appointments, and share schedule and calendar information. Further, the PIM may be intended for use by a single individual for personal information or for use by a company or organization to provide information related to that persons involvement with the company or organization. The use of the term PIM or PIM program herein refers to any program that includes some or all of the above described calendar or scheduler functions, or any other functions those skilled in the art associate with PIMs.

The server 4 includes a PIM database 22 maintaining user PIM information and a PIM server 24 for gathering and filtering data from wireless devices 2 for the users of the system. The PIM database 22 may be implemented using any database technology known in the art, e.g., relational database, object oriented database, etc. Although FIG. 1 only shows one wireless devices 2, the server 4 and PIM database 22 may maintain data for multiple wireless devices 2 and users.

In the described implementations, the PIM client 20 gathers position coordinates for the PIM server 24. The PIM server 24 then uses the position coordinates to supplement the user calendar records with information on what the user actually did for time periods within a day. The user could then view this enhanced calender including listings of scheduled appointments as well as information describing the actual location and activities of the user and descriptions thereof. The term “location” and “geographic location” as used herein refer to any location that may be mapped and ascertained. Such location or geographic location may be any location on the surface of the earth or the earth's atmosphere, or outer space, that can be expressed as a position coordinate in space. The term “location” or “geographic location” may refer to a specific position coordinate in space, e.g., an X, Y, Z coordinate, or a boundary or area of coordinates. Additionally, the location may be expressed as a vector. The term “position coordinate” as used herein refers to any of a set of numbers used in specifying the location of a point in space, or any one of a set of variables used in specifying the state or motion of an entity, such as a wireless unit or person, associated with the position coordinate.

The PIM server 24 includes the program logic that responds to data requests from PIM clients 20, accesses the PIM database 22 to perform database operations, and performs other data management operations related to managing the PIM database 22. The PIM server 24 may include a database management system (DBMS) known in the art or include an interface to access a DBMS program in a manner known in the art to perform operations with respect to the PIM database 22. The PIM server 24 may implement any database programming techniques for performing operations in the PIM database 22. For instance, the PIM server 24 may implement separate application programs for performing database operations or implement database stored procedures to perform database operations. The PIM client 20 includes those program components that gather coordinate and location information as described herein, communicates with the PIM server 24, and renders calendaring information at the wireless device 2.

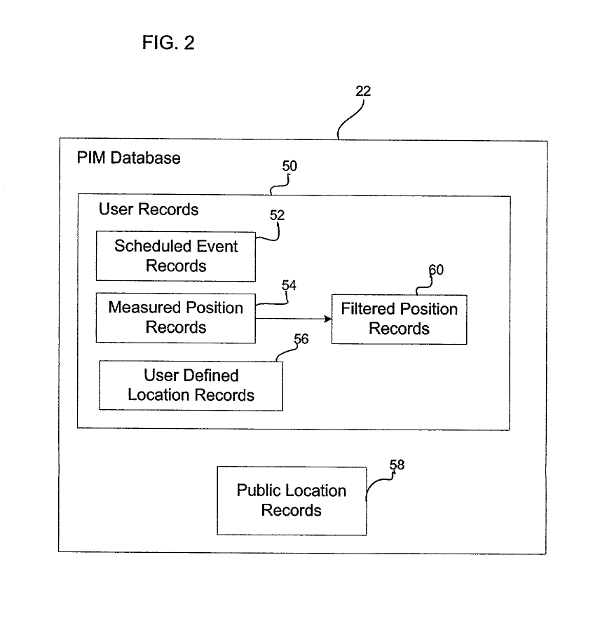

FIG. 2 illustrates the data components of the PIM database 22 maintained by the server 4. The PIM database 22 includes a plurality of user records 50 for each user of a wireless device 2 participating in the wireless computing environment described herein. Each user record 50 includes one or more user scheduled event records 52, measured position records 54, and location records 56 and 58. From the measured position records 54, the PIM server 24 generates filtered position records 60 that provide information on user geographic location and activity for time periods, such as information for a period of fifteen minutes, twenty minutes, one hour, etc.

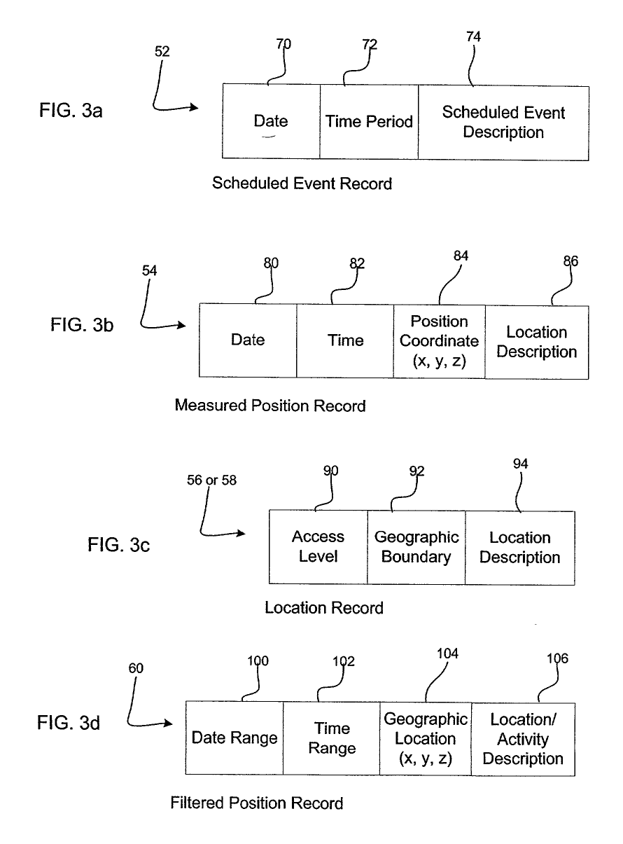

FIG. 3a illustrates fields in a user scheduled event record 52, including a date 70, time period 72 indicating a time range of the event, and a scheduled event description 74 providing information on the nature of the scheduled event. Through the client PIM 20 software, a user could use the input mechanism 16 to schedule a calendar event and create a scheduled event record 52. Additionally, the user could enter scheduled events from a desktop computer (not shown) that communicates with the server 4 via a network such as the Internet. The scheduled events may be shown in a calendar rendered on the display 18. Additionally, the scheduled events may be shown in a calendar rendered on another computer capable of accessing the server user records 50 in the server 4, such as a desktop computer communicating with the server 4 over the Internet.

FIG. 3b illustrates fields in a measured positioned record 54 for a user, including a date 80 and time 82 the position was measured, a position coordinate 84 expressed as a unique three dimensional x, y, z geographic coordinate on the surface of the earth, and a location description 86 providing descriptive information on the location. In the described implementations, the PIM client 20 periodically generates a measured position record 54 by obtaining the measured position coordinate (x, y, z) and the current time from the locator 14 (which may, in certain implementation interact with external components to provide the location and position coordinate). The location description 86 may be obtained locally at the wireless device 2 or determined subsequently by the server 4 as described in the following implementations.

FIG. 3c illustrates the fields maintained in the user defined 56 and public 58 location records. An access level field 90 indicates which users can be allowed to use the location record 56 or 58 to determine information about a location. The public location record 58 has public level access such that the PIM server 24 can consider a public location record 58 for any user in the PIM database 22. A user location record 56 can only be considered for the particular user that defined the location record 58 and any other authorized users in the system, as indicated by the access level 90. A geographic boundary field 92 defines a boundary of a defined region in three dimensional space. A location description field 94 provides a description of the location, which may include text, images, sound, movies, etc. A company maintaining the server 4, such as a telecommunication service provider, can use satellite maps and other information to determine the geographic boundaries in three dimensional space of various buildings and businesses. Business could register their geographic boundaries. Public location records 58 may then be generated for each of these determined geographic boundaries and include a description of the location within the geographic boundary.

The user specified location records 56 are generated by the user to provide information to include with the user's calendar. For instance, the user may obtain from a third party, such as a mapping company or organization, the geographic boundaries of an office or building and provide geographic boundary and location description information to the server 4 to include in a user location record 56. In another implementation, the user can activate a geographic boundary definition mode on the wireless device 2 to record position coordinates of a geographic boundary using the locator 14. In this geographic boundary definition mode, the user may walk or otherwise travel around a geographic area. While moving through the geographic area, the wireless device 2 would determine the x, y, z position coordinates at frequent intervals using the locator 14. The PIM client 20 or PIM server 24 can then use the determined position coordinates to determine a geographic boundary bounding all of the coordinates generated in the geographic boundary definition mode. This determined geographic boundary would then be included in the geographic boundary field 92 of the eventual user defined location record 56 stored in the user records 50 in the database 22. The user may further use the input mechanism 16 to enter information to include in the location description field 94 and the access level 90. The user access level 90 may specify that the user location record 68 be accessible to the user and other specified users, thereby limiting access of the location record 56 to a user defined group.

FIG. 3d illustrates a filtered position record 60 generated from a range of consecutive position records 54 having a same location description 86. The date range 100 and time range 102 for the generated filtered position record 60 would comprise the first and last dates 80 and times 82 of the consecutive position records 64 having the same location description 86. In this way, a single filtered position record 60 represents the data in multiple consecutive position records 54 having a same location description 106. Alternatively, a filtered position record 60 can consolidate multiple position records 54 that have position coordinates 84 within a predetermined proximity, without consideration of the location description 86. A geographic location field 104 indicates the common geographic location of the position records 60 having the same location description 86, which could include the geographic boundary from a location record 56 or 58 if the location description 86 of the consolidated position records 60 was determined from a location record 56 or 58.

Additionally, if algorithms in the PIM server 24 determine that a range of measured position records 54 define an activity, e.g., driving, walking, flying in an airplane, etc., then a filtered position record 60 would be generated for those position records 54 defining the activity. The date range 100 and time range 102 for the generated filtered position record 60 would comprise the first and last date 80 and time 82 of the consecutive position records 64 defining an activity and the location/activity description 106 field for this filtered position record 60 would include a description of the determined activity.

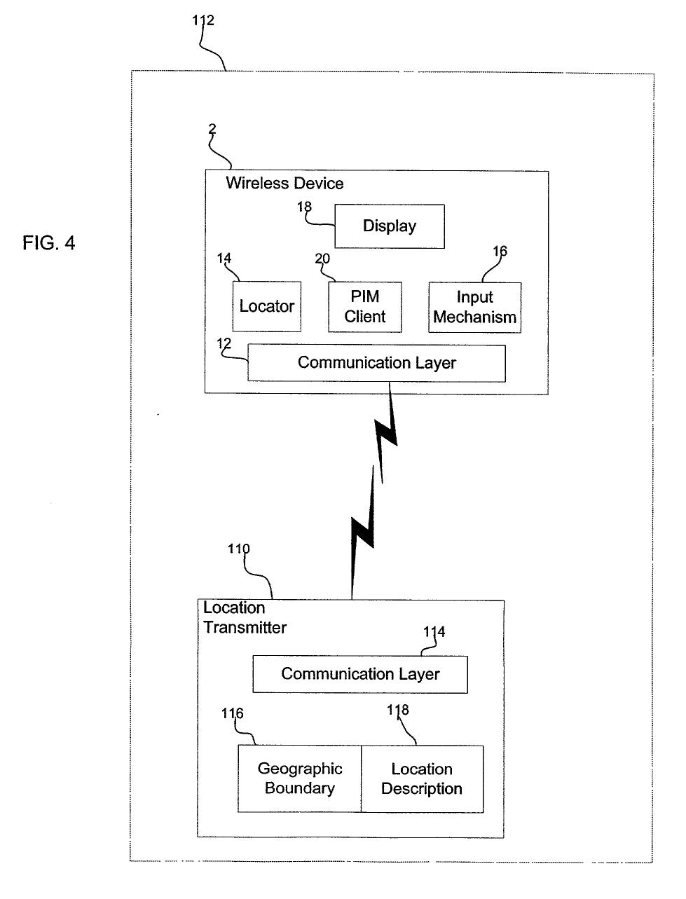

FIG. 4 illustrates an additional implementation of the telecommunication environment for obtaining geographic boundary information. A location transmitter 110 is maintained in a geographic location or boundary 112, such as an office, building, designated region, etc., and includes a communication layer 114 to transmit data throughout the geographic location 112. For larger geographic locations, multiple location transmitters 110 may be deployed to transmit throughout the entire geographic location 112. The location transmitter 110 maintains a geographical boundary 116, defining a region of x, y, z coordinates, and a location description 118 providing descriptive information on the geographic boundary 112. The local transmitter 110 is capable of transmitting the geographic boundary 116 and location description 118 through the communication layer 114 to any receiving device within the geographic boundary 102. For instance, the communication layers 12 and 114 of the wireless device 2 and location transmitter 110, respectively, may implement Bluetooth technology. In such Bluetooth implementations, the location transmitter 110 may continually transmit packets containing an Inquiry Access Code (IAC) to establish communication with any wireless devices 2 within the geographic boundary 112. The wireless device 2 may then respond to establish a connection with the local transmitter 110. Upon establishing the connection, the local transmitter 110 may then transmit the geographic boundary 116 and location description 118 through communication layer 114 to the communication layer 12 of the wireless device 2. Further details of Bluetooth communication technology are described in the publication “Bluetooth(TM): Connect Without Cables” by Jennifer Bray and Charles F. Sturman (Copyright 2001, Prentice Hall), which publication is incorporated herein by reference in its entirety. In alternative implementations, the communication layers 12 and 114 may utilize wireless communication protocols other than Bluetooth known in the art to perform the communication operations described herein, such as the wireless LAN architecture standard proposed in IEEE 802.11.

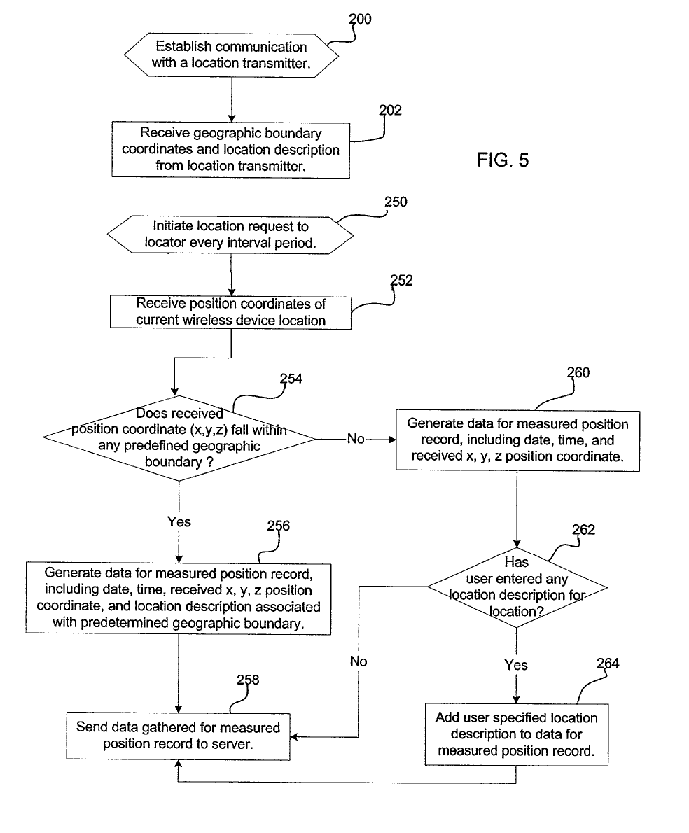

FIGS. 5-7 illustrate logic implemented in the PIM client 20 and server 24 to gather and utilize position information concerning the wireless device 2. FIG. 5 illustrates logic implemented in the PIM client 20 to gather position information to provide to the PIM server 24 to include within measured position records 54 in the database 22. At block 200, the wireless device 2 establishes communication with a location transmitter 110, using the Bluetooth technology or other wireless technology known in the art. After establishing a connection with the location transmitter 110, the PIM client receives (at block 202) a geographic boundary 116 comprised of X, Y, Z coordinates defining a three dimensional boundary on earth and location information describing the geographic boundary 116.

To provide data to the PIM server 24, the PIM client 20 performs steps 250 through 264 in interval time periods, e.g., every few seconds, minute, etc., to measure the current location and generate measured position records 54. At block 250, the PIM client 20 initiates a location request to the locator 14 or other unit to determine the current position coordinate (x, y, z) of the wireless device 2. Upon receiving (at block 252) the position coordinate from the locator 14, the PIM client 20 determines (at block 254) whether the received position coordinate falls within any predefined geographic boundaries supplies by a location transmitter 110, the PIM server 24, a user defined location record 56, or any other geographical boundary maintained by the PIM client 20. If so, the PIM client 20 generates (at block 256) data for a measured position record 54, including the received position coordinate, the date and time the coordinate was determined, and any location description associated with the predefined geographic boundary including the received position coordinate. The gathered data is then sent (at block 258) to the PIM server 24 to include as a position record 54 in the user records 50.

If (at block 254) the received position coordinate did not fall within any predefined geographic boundary, then the PIM client 20 generates (at block 260) data for a measured position record 54 including the received X, Y, Z position coordinate and the date and time the coordinate was measured. If (at block 262) the user has entered through the input mechanism 16 any location description for the current location through the input mechanism 16, then the PIM client 20 adds (at block 264) the user specified location description to the data for the measured position record. From block 264 or the no branch of block 262, the PIM client 20 transmits the data for the measured position record 54 to the PIM server 24 to include in the user records 50.

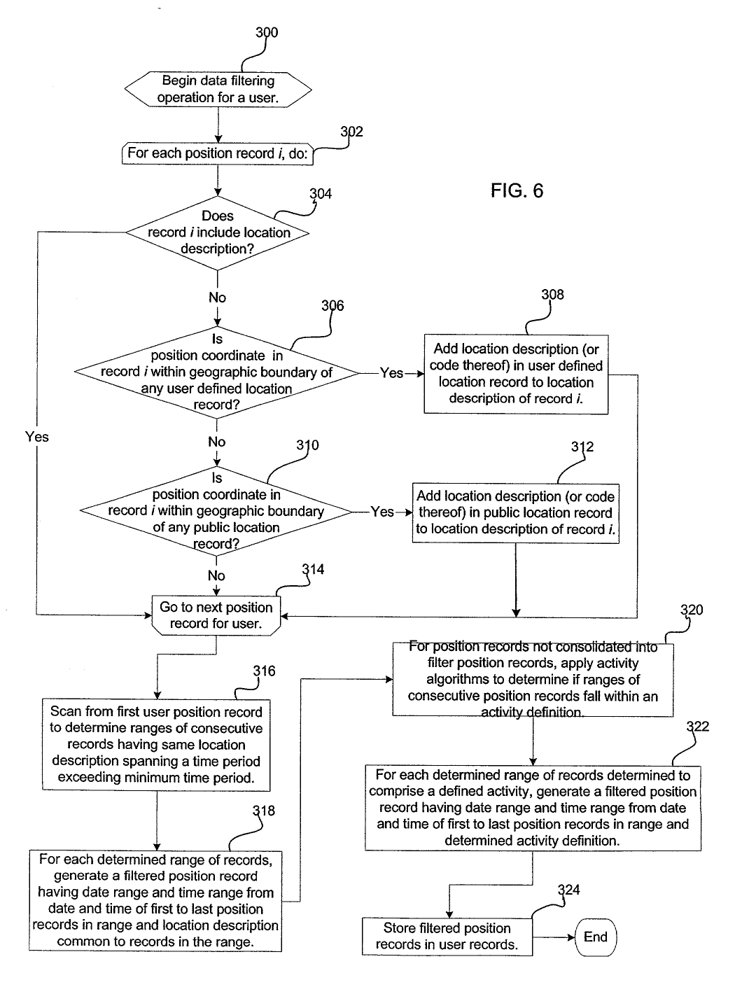

FIG. 5 provides logic implemented in the PIM client 20 to gather the position records for each measured coordinate. FIG. 6 illustrates logic for a filtering algorithm that consolidates and interprets the measured position records 54 and generates filtered position records 60 that provide information on the user's whereabouts and activities for time periods. The filtering algorithms used to generate the filtered position records 60 may be implemented in either the PIM client 20 or PIM server 24. In the event that the PIM client 20 (FIG. 1) executes the filtering algorithm, then the PIM client 20 would transmit the filtered position records 60 to the PIM server 24 to store in the PIM database 22.

With respect to FIG. 6, control begins at block 300 with the invocation of the filtering algorithm for the user records 50 of a particular user. A loop is performed from blocks 302 to 314 for each measured position record i in the user records 50 that has not yet been subject to filtering to add location description information 86 to the measured position record 64 if such data was not provided by the PIM client 20. If (at block 304) the measured position record i does not include any location description 86 data, then a determination is made (at block 306) as to whether the position coordinate 84 data in record i is within the geographic boundary of any user defined location records 56 of the user being considered. If so, then the location description 94 for the user defined location record 90 is added (at block 308) to the location description 86 data for the measured position record 64. If (at block 306) a geographic boundary was not located in the user defined location records 56, then a determination is made (at block 310) whether the position coordinate 84 data in record i is within the geographic boundary of any public location records 58. If so, then the location description 94 for the public location record 58 is added (at block 312) to the location description 86 data for the measured position record 64. From the yes branch of block 304 (if there is already location information added by the PIM client 20) or from blocks 308 or 312, control proceeds to block 314 to consider all the measured position records 54 for the user. The related application entitled “Method, System, and Program for Providing User Location Information for a Personal Information Management System”, having attorney docket no. AUS920010221US1, which is incorporated by reference in its entirety above, provides additional implementations for obtaining location description information from the user records for other entities and persons in the PIM database 22.

After the measured position records 64 are supplemented with location information from user defined 56 or public 58 location records, then control proceeds to blocks 316 to generate the filtered position records 60 that are particularly suited for use in a PIM or calendaring program. At block 316, the filter scans from the first user position record 54 to determine ranges of consecutive position records 54 having the same location description 86 spanning a time period exceeding a minimum time period. Thus, the filter is looking for position records indicating that the user was at a same location for a minimum time. The minimum time may be a time period of sufficient length that would be meaningful to display in a PIM interface, such as a calendar or schedule, e.g., 10 minutes, etc. For each determined range of records, a filtered position record 60 is generated (at block 318) having a date 100 and time 102 ranges from the date and time of the first to last position records in the determined range and having a location description 106 that is the common location description 86 found in the position records 54 in the determined range. In this way, a single filter position record 50 is generated that defines a location position that was maintained for a minimum time.

At block 320, activity algorithms may then be applied to those position records not consolidated into filtered position records 58 at block 316 and 318. An activity algorithm would analyze a series of consecutive measured position records and based on a rate of change in distance per unit of time, determine a predefined activity associated with the position records. For instance, a range of consecutive measured position records 54 whose position coordinate 84 (x, y, z) is rapidly changing may indicate that the user is traveling in an automobile or other transportation vehicle. Other rate of changes may indicate other activities, e.g., walking, running, bicycle riding, etc. For each determined range of measured position records 54 that define an activity, a filtered position record 60 is generated (at block 322) having a date 100 and time 102 ranges from the date 80 and time 82 of the first and last measured position records 54 in the range and an activity description field 106 set to the activity determined for the range. The geographic location field 104 may comprise a range of first and last locations for the activity, wherein the first location would comprise the location 84 data from the first measured position record 64 in the range for the activity and the last location would comprise the location data 84 from the last record 84 in the range. Thus, in certain described implementations, a filtered position record 60 indicates a time period during which a user was at a location, defined by a geographic boundary or a time period during which the user was engaged in an activity involving movement from one location to another.

The filtered position records 60 are then stored (at block 324) in the PIM database 22 for later use. The filtered position records 60 provide more useful descriptive information than the measured position records 54 because they indicate time periods spent at meaningful geographic locations or engagement in a particular activity.

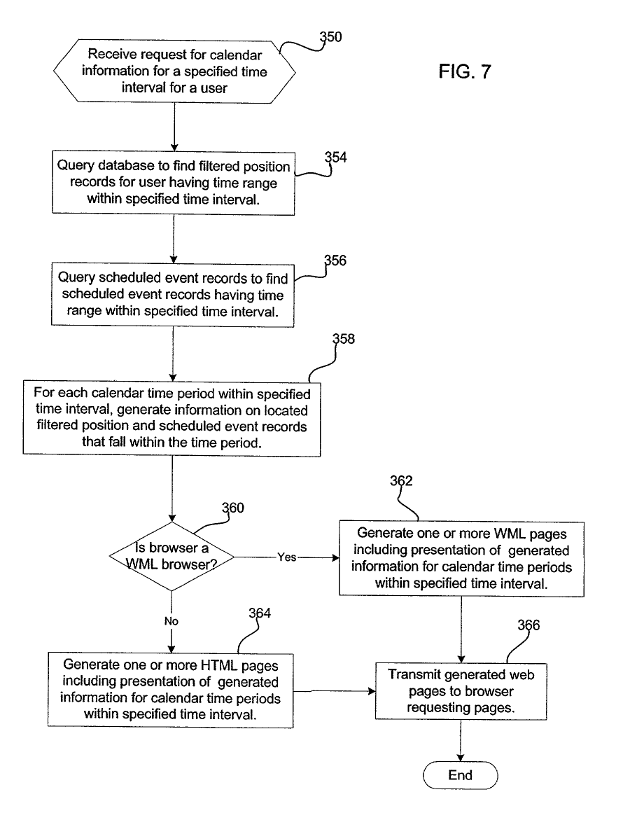

FIG. 7 illustrates logic implemented in the PIM server 24 to generate calendar information that can be displayed at the wireless device 2 or some other computer in communication with the server 4, such as a desktop computer accessing the server 4 over the Internet. Control begins at block 350 with a request for PIM information for a time interval for a user. In response, the PIM server 24 queries the PIM database 22 for filtered position records 60 (at block 354) and scheduled event records 52 (at block 356) of the user within the specified time interval. The PIM server 24 then generates (at block 358) for each calendar time period, e.g., every half-hour, hour, etc., information on the scheduled event description 74 and the location/activity description 106 (FIGS. 3a, d) in the located scheduled event 52 and filtered position 58 records, respectively, that fall within the calendar time periods that span the specified time interval.

If (at block 360) the viewer program requesting the calendar information for the time period is a WML browser on a small device, e.g., the wireless device 2, then the PIM server 24 generates (at block 362) one or more WML pages including a presentation of the information generated for each calendar time period in the user specified time interval including information on user scheduled events and actual location/activity. Otherwise, if the viewer or browser requesting the calendar information includes a larger display area, then the PIM server 24 generates (at block 364) one or more HTML pages including the presentation of the generated calendar information. From blocks 362 or 364, control transfers to block 366 to transmit the generated web pages to the browser requesting that page. Alternatively, the PIM server 24 may include the generated calendar information in an Extensible Markup Language (XML) or other file that is sent to the PIM client 20 to render on the local display. Thus, the calendar information presented to the user may include a description of user scheduled events as well as information on the geographical locations the user associated with the wireless device 2 visited during the specified time interval.

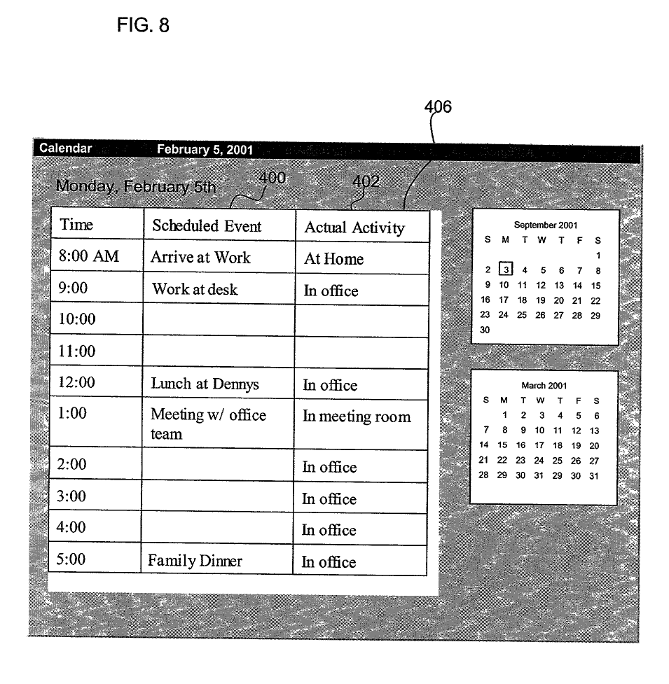

FIG. 8 illustrates an example of calendar information for the user specified time period presented in a calendar window 400 rendered on a computer display monitor. As shown, the calendar displays both user scheduled events 402 from the scheduled event records and actual location/activity 404 from the filtered position records for calendar times 406 during the specified time interval. In this way, the user may compare what was scheduled with what actually materialized. Moreover, in implementations where the PIM server 24 updates the user calender information in real time and generates real time filtered position records, the calendar 400 could display the user's current geographical location. This information could be useful for business associates and others interested in the user's location. Additionally, the actual location/activity 402 may be displayed in an abbreviated format. The user may use an input device to selectively display further details on the actual location/activity. For instance, the user may move a mouse input device over the displayed abbreviation of the actual location/activity or click the displayed abbreviation to cause the display of more detailed information on the actual location/activity in the calendar window 400.

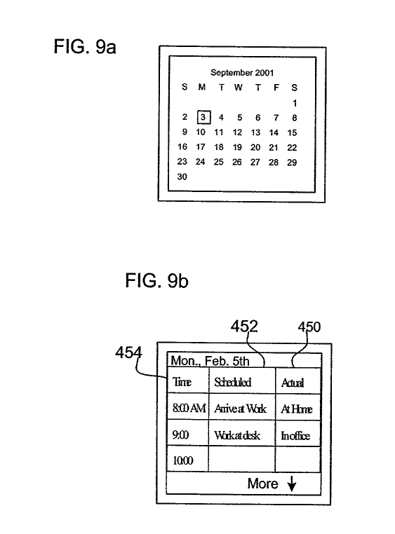

FIGS. 9a, b illustrate how calendar information may be displayed on a display 18 of a wireless device 2 having limited display space. FIG. 9a illustrates a small displayed monthly calendar. Upon user selection through the input mechanism 18 of a particular day, e.g., February 5^{th}, the PIM client 20 displays the view shown in FIG. 9b which provides information of scheduled events 450 and actual user location/activity 452 for a portion of the calendar times 454 during the user requested time interval. The user can use the input mechanism 18 to scroll downward to view further calendar entries.

The described implementations provide a technique for gathering and utilizing user position information for use with a PIM or calendaring program. This position information may be provided to the user and those authorized by the user to track actual activity versus scheduled activity.

### Accessing Event Information From External Sources

In additional implementations, a user of wireless device 2 may observe an advertisement or promotion of an event, service or products that are available at a particular time and location. For instance, the user may see a billboard or magazine page advertising the event, listen to a promotion for an event on radio, television, an Internet web site, etc. The promotion may provide a code for the event. The user may enter the code as input into the wireless device 2 to cause a scheduled event record 52 (FIG. 3a) to be added to the user's PIM database records 50 (FIG. 2). The scheduled event may comprise an entertainment, public service or sporting event, corporate or public meeting, speaking engagement, etc. Still further, the event may comprise a special sale or offering from a vendor, such as retail operator, restaurant, etc. The event promoter seeking to provide scheduled event records on an event may comprise a commercial or non-commercial entity.

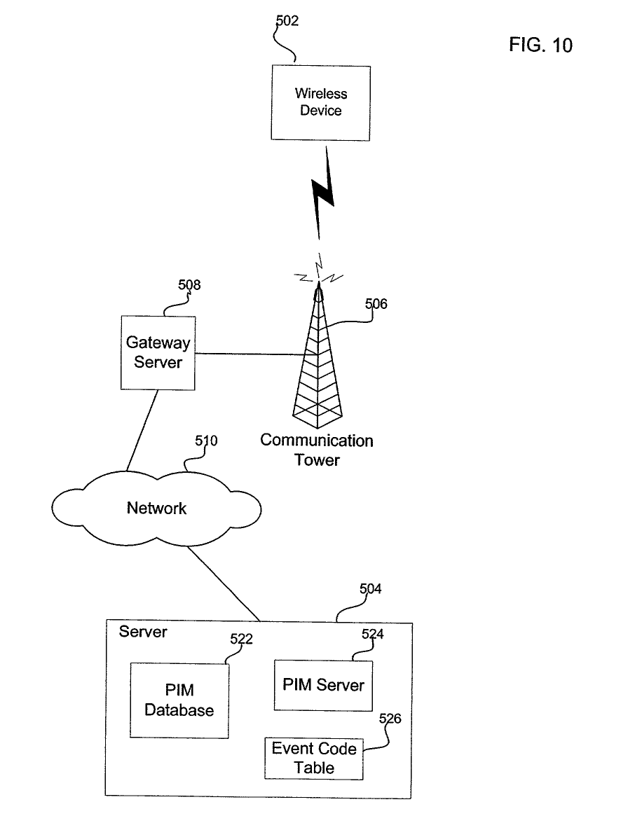

FIG. 10 illustrates one implementation where a wireless device 502 is in communication with a server 504 that includes all of the components described with respect to FIG. 1. However, the server 504 additionally maintains an event code table 526 that provides a mapping of event codes to scheduled event records from event promoters. For instance, different vendors may contract with the owner or manager of the PIM database 522 and server 524 to include their scheduled event records in the event code table 526, where the scheduled event record is associated with a unique code. The scheduled event record 552 may indicate the date 70, time period 72 (FIG. 3a) and a description of the event being promoted. In certain implementations, the vendor may pay a fee to the PIM database 522 provider to allow the promoter's scheduled event records to be made available to PIM database 522 users. The PIM database 522 provider may, in turn, reduce costs or provide PIM database 522 calendar services free to increase their share of wireless device 502 users and, in turn, earn revenue from event promoters to add their scheduled event records to the event code table 526.

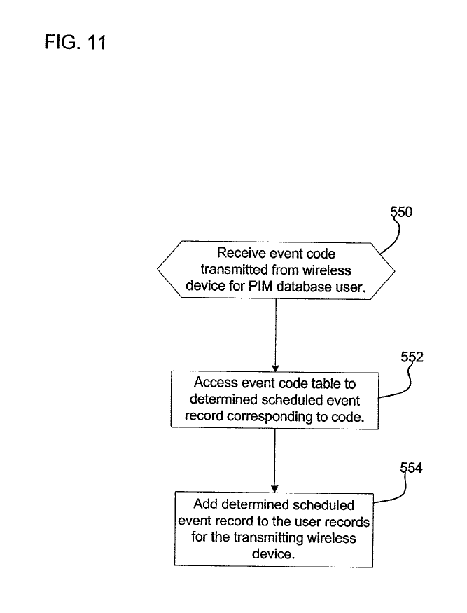

FIG. 11 illustrates logic implemented in the PIM server 524 to process event codes received from users. At block 550, the PIM server 524 receives an event code transmitted by a wireless device 502. The event code may comprise any alpha-numeric string and may be entered through an input mechanism on the wireless device 502, such as the input mechanism 16 described with respect to FIG. 1, which includes any known input mechanism known in the art to enable the entry of any type of data, including text, voice data, audio, images, movies, etc. The user at the wireless device 502 may have manually entered the event code. Alternatively, the event code could have been entered into the wireless device via speech from the wireless device user or from an audio signal transmitted from the medium through which the user observed the promoted event, such as a radio, television, web page, etc. The event code may further be transmitted via infrared signals or flashing lights from the advertising medium, such as the case if the advertising medium is a television or Internet web page. In response to receiving the event code, the PIM server 524 determines (at block 552) from the event code table 526 the scheduled event record corresponding to the event code and adds (at block 556) the determined scheduled event record to the user records 50 (FIG. 2) for the wireless device 502 that transmitted the event code.

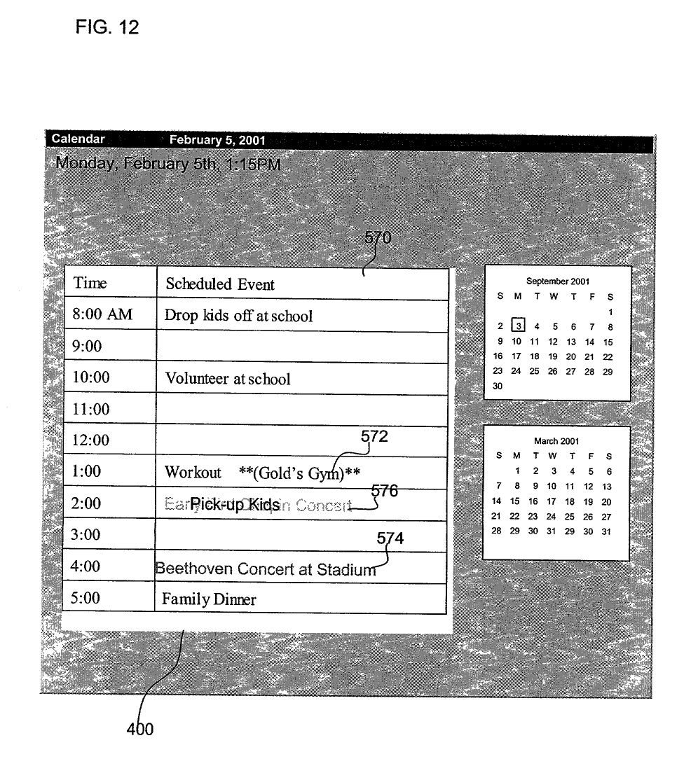

Once the scheduled event is added to the user records 50 in the PIM database (FIG. 2), the user then may review the scheduled event in the calendar display at the wireless device 502 or other system, such as the displays shown in FIGS. 8, 9a, b. In additional implementations, the scheduled event corresponding to the code may be added to the user records 50 as a shadowed event. A “shadowed event” is an event that is displayed in the user's calendar as a non-committed event, not a scheduled event. Shadowed events are displayed “optional events” that the user may selectively add to the regular scheduled event records 52 (FIG. 3a) that are displayed as regular scheduled events. In this way, the shadowed events are not “hardened” scheduled events until the user selects to add the shadowed event to the user schedule by converting the shadowed event to a scheduled event record 52 in the user records 50. For instance, in certain implementations, the shadowed event does not override or conflict with a regular user scheduled event record 52. If a user schedules two user events at the same time, for which separate scheduled event records 52 would be created, then a conflict signal may be generated notifying the user of the conflicting scheduled events. However, for shadowed events, if the shadowed event is scheduled at the same time as a regular user scheduled event, then the shadowed event may be displayed as a transparency over the regular scheduled event. In such case, no conflict signal would be generated indicating an attempt to schedule conflicting appointments because the shadowed event is an event the user is monitoring and is not considered an event the user is adding to their own schedule. The user may select to accept or “harden” the shadowed event, which would transform the shadowed event into a user scheduled event record 52. User selection to harden the shadowed event into a regularly scheduled event may override any previous scheduled event for that time slot. Further details on presenting shadowed scheduled events in a user's calendar using the PIM database 22 are described in the copending and commonly assigned patent application entitled “Method, System, and Program for Accessing Calendar Information for Shadowed Users from a Database”, having U.S. application Ser. No. 09/888,471 and filed on Jun. 25, 2001, which patent application is incorporated herein by reference in its entirety. FIG. 12 provides an example of displayed shadowed events 574 and 576, which are displayed in a different manner, i.e., in a lighter level of darkness, than the actual scheduled events 572.

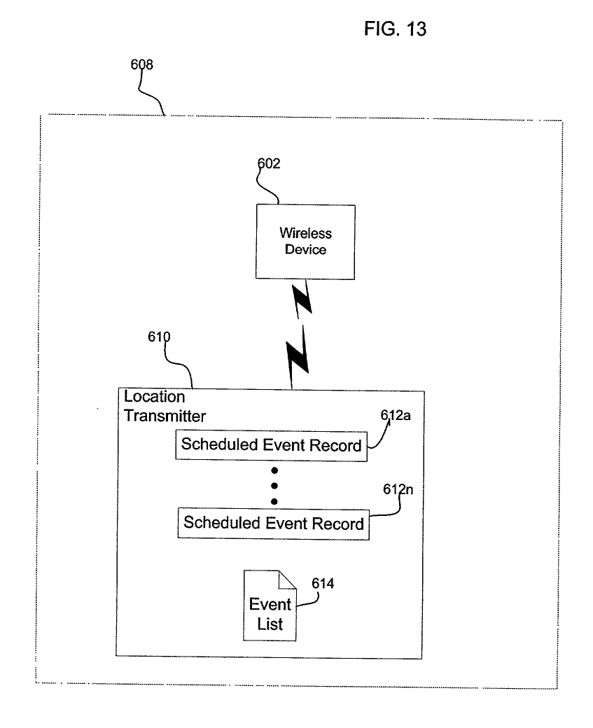

FIG. 13 illustrates a further implementation of providing the promoted scheduled event records where the wireless device 602 communicates with a location transmitter 610, including the components described with respect to the computing environment in FIG. 4. In the implementation of FIG. 13, the location transmitter 610 additionally includes a plurality of scheduled event records 612a . . . n for events being promoted and a document comprising a list of scheduled events 614. For instance, the list may comprise a series of scheduled sporting events, television shows, etc. In certain implementations, the operator of the location transmitter 610 may charge a fee to event promoters to make their scheduled event records available through the location transmitter 610 broadcasts to wireless devices 602. In this way, the location transmitter 610 operator is in a business similar to that of highway billboard providers that lease space. However, in the described implementations, the location transmitter 610 operator may lease advertising space to multiple advertisers, i.e., allow multiple event promoters to make their scheduled event records 612a . . . n available through the location transmitter 610.

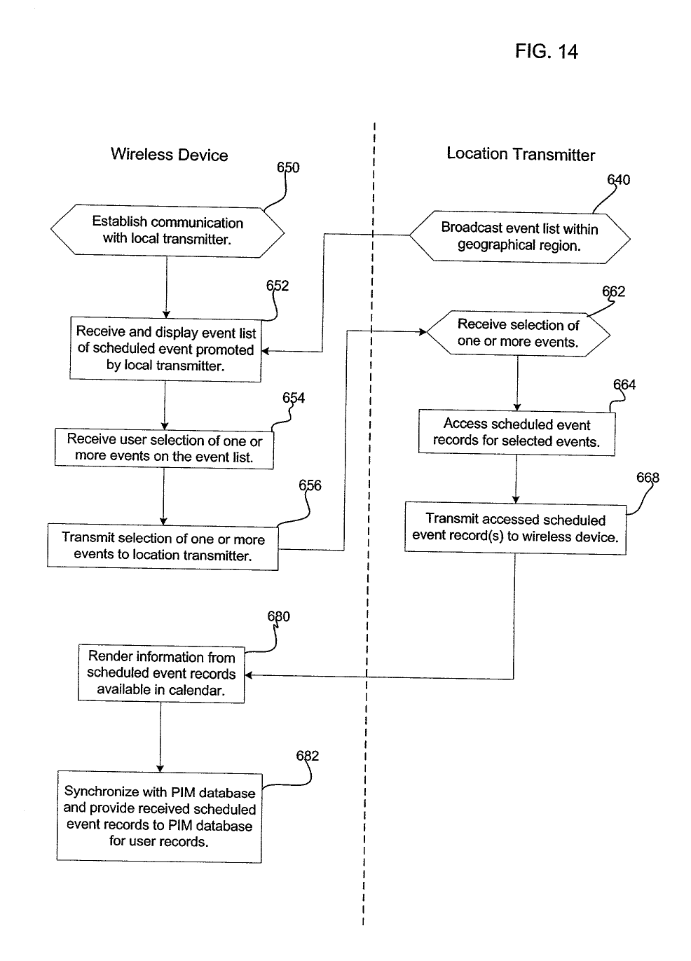

FIG. 14 illustrates logic implemented in the wireless device 602 and location transmitter 610 to provide scheduled events from the location transmitter 610 to the user of the wireless device 602. Control begins at block 640 with the location transmitter 610 broadcasting the event list 614. At the wireless device 602, upon establishing communication with the location transmitter 610, the event list is received (at block 652) and displayed. User selection of one or more of the events on the event list 614 is entered (at block 654) into the wireless device 602. The user would then select a control through the input mechanism of the wireless device 602 to cause the wireless device 602 to transmit (at block 656) user selection of one or more events to the location transmitter 610. Upon receiving (at block 662) selection of one or more events, the location transmitter 610 accesses (at block 664) the scheduled event record 612a . . . n for each event the user of the wireless device 602 selected from the event list 614 and transmits (at block 668) each accessed scheduled event record 612a . . . n to the transmitting wireless device 602.

Upon receiving the scheduled event records 612a . . . n from the location transmitter 610, the wireless device 602 will render (at block 680) the scheduled event records for calendar display as a regular or shadowed scheduled event. At some point, the wireless device 602 synchronizes with the PIM database 622 and transmits new information generated at the wireless device 602, such as scheduled event records 612a . . . n received from a location transmitter 600.

In alternative implementations of FIGS. 13 and 14, the location transmitter 610 may maintain only one scheduled event record 612a that is transmitted to wireless devices within the broadcasting range 608 of the location transmitter 610. In such case, upon receiving the scheduled event record 612a, the wireless device 602 may prompt the user to accept the scheduled event record. In response to user action, such as a single-click of an accept button, the scheduled event record 612a is then added to the user's calendar records and eventually added to the PIM database during synchronization. In still further implementations, the one or more scheduled event records 612a . . . n may be automatically added to the user's calendar records at the wireless device 602 or directly to the PIM database as shadowed scheduled event records that the user may view in shadowed format, as shown in FIG. 12, and then later select to transfer to their regular scheduled event records 52 (FIG. 2).

In yet further implementations of FIGS. 10 and 11, the event code may be transmitted by the source of the promotional advertisement of the event via audio transmission and detection and decoding by the wireless device, via infrared transmission or any other form of transmission, e.g., Bluetooth. Upon receiving the event code, the wireless device 502 may then transmit the code to the PIM server 524 automatically, without any intervening user action, or transmit the event code in response to a user authorization, such as the user selecting a displayed “OK” button to cause the wireless device 502 to transmit the received code to the PIM server 524. Still further, a plurality of event codes may be inputted into the wireless device 602, from the user or transmitted from some external device via wireless transmission. All the event codes received at the wireless device 502 may then be automatically transmitted to the PIM server 524 to include in the PIM database 522, with user intervention, or selectively transmitted to the PIM server 524 in response to one or more user selection actions.

### Additional Implementation Details

The described aspects of the invention, including the logic described with respect to the PIM client and server and any other devices, may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which the invention is implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The scheduled event sponsored by the event provider may comprise any event within a geographical boundary and within a specific time range, such as an entertainment event, gathering, party, product sale, promotional event, conference, convention, etc.

In the described implementations, the wireless device obtains the position coordinates and time and date information and transmits the data to the server 4. In alternative implementations, telecommunication devices or towers can detect the location of the wireless device and transmit the data for the measured position record 54 directly to the server 4. In such implementations, the wireless device would not be involved in transmitting position coordinates for the measured position records.

In the described implementations, the event provider server 530 was described as located external to the PIM server 4. In alternative implementations, the event provider server 530 may be implemented within the server 4 as a supplemental service performed by the PIM server 22.

In the described implementations, scheduled events and location/activity information were displayed together in a user calendar view. Alternatively, the calendar view may selectively display only scheduled events or location/activity information.

The described implementations presented the scheduled event and location/activity information at different times during a user specified time interval. However, the generated location/activity information may be presented in alternative formats. For instance, the user may generate a display of all locations visited and activities, and the time period during which the location was visited or activity performed would be displayed under the location/activity display.

FIGS. 3a, b, c, d illustrate one implementation of the data structures used to maintain the information used in the described implementations. However, those skilled in the art will recognize that the there are numerous ways the data shown in FIGS. 3a, b, c, d may be organized in data structures and a database for storage and retrieval.

In the described implementations, the PIM server 24 transmitted the PIM information to the client PIM 20 or some other client to display in a browser, such as a WML or HTML browser. In alternative implementations, the PIM server 24 may provide the generated PIM information in alternative presentation and file formats, or alternative text markup languages than those described herein. Moreover, the location information presented to the user through the browser may present information in alternative presentation formats, such as audio, movies, etc. For instance, the calendar may display a hypertext description of the visited location. User selection of the hypertext description could present a movie or audio file about the visited location.

In the described implementation, the generated location was expressed as an x, y, z position coordinate. However, as discussed, the position coordinate may be expressed as any set of numbers used in specifying a location in space, or may comprise a code or descriptor defining a location in space.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method implemented by a wireless device to provide information on a scheduled event in a personal information manager (PIM) application, wherein the wireless device performs:
receiving a code;
transmitting the received code to a server including a calendar database for the user of the transmitting wireless device including scheduled event records;
receiving from the server a scheduled event record including information on one scheduled event associated with the code; and
rendering calendar information at the wireless device including information on the scheduled event included in the scheduled event record.

2. The method of claim 1, wherein the code is entered via a user input mechanism on the wireless device.

3. The method of claim 1, wherein the code is transmitted to the wireless device via a wireless transmission medium.

4. The method of claim 3, wherein the code is transmitted to the wireless device, transmitted from the wireless device to the server, and rendered at the wireless device automatically without any intervening user action.

5. The method of claim 1, wherein the scheduled event record comprises a shadowed scheduled event record, wherein information on the shadowed scheduled event is displayed with the calendar information at the wireless device as a non-committed event.

6. The method of claim 1, wherein the code is transmitted to the server in response to user input at the wireless device.

7. The method of claim 1, wherein receiving the code further comprises receiving a plurality of codes, wherein transmitting the code to the server comprises transmitting the plurality of codes, wherein receiving the scheduled event record from the server further comprises receiving one scheduled event record for each transmitted code, and wherein rendering calendar information at the wireless device including information on the scheduled event comprises rendering information on scheduled events for the received scheduled event records.

8. A method implemented by a server to provide scheduled events for users of wireless devices, wherein the wireless devices are capable of displaying calendar information on scheduled events, comprising:
receiving a code transmitted from the wireless device;
determining a scheduled event record corresponding to the received code; and
transmitting the determined scheduled event record to the wireless device that transmitted the code, wherein the wireless device is capable of rendering calendar information including information on the scheduled event included in the transmitted scheduled event record.

9. The method of claim 8, further comprising:
providing a data structure including a plurality of codes and associating with each code one scheduled event record, wherein determining the scheduled event record corresponding to the received code comprises searching the data structure for one code matching the received code transmitted from the wireless device and the associated scheduled event record.

10. The method of claim 8, wherein a plurality of codes are received from the wireless device and one determined scheduled event record for each code is transmitted to the wireless device transmitting the plurality of codes.

11. The method of claim 8, wherein scheduled event records and codes are provided for different event promoters.

12. The method of claim 11, further comprising:
charging a fee to the event promoter to include one scheduled event record in the data structure in order to make scheduled event records for the promoter available to wireless devices in response to transmissions of the code associated with the scheduled event record.

13. A method implemented by a wireless device to provide information on a scheduled event to a personal information manager (PIM) application, wherein the wireless device performs:
receiving a scheduled event record including information on a scheduled event transmitted from a transmitter system including at least one scheduled event record when the wireless device is within a broadcast range of the transmitter system;
rendering calendar information at the wireless device including information on the scheduled event included in the scheduled event record; and
transmitting the scheduled event record to a server including a calendar database for the user of the transmitting wireless device including scheduled event records, wherein the server stores the transmitted scheduled event record with the calendar database records for the user of the wireless device.

14. The method of claim 13, further comprising:
receiving user input to accept the scheduled event record, wherein information on the scheduled event in the scheduled event record is rendered with calendar information and wherein the scheduled event record is transmitted to the server to include in the calendar database for the user of the wireless device after receiving the user input to accept the scheduled event record.

15. The method of claim 13, further comprising:
receiving a list of scheduled events from the transmitter system;
receiving user input selecting at least one of the scheduled events on the list; and
transmitting information on the selected at least one scheduled event to the transmitter system, wherein receiving the scheduled event record further comprises receiving one scheduled event record for each selected scheduled event.

16. The method of claim 15, wherein rendering the calendar information at the wireless device further comprises rendering information on the scheduled event included in each received scheduled event record, and wherein transmitting the scheduled event to the server further comprises transmitting each scheduled event to the server.

17. A method implemented by a transmitter for transmitting information on scheduled events, comprising:
providing information on at least on scheduled event record, wherein each scheduled event record includes information on a scheduled event; and
transmitting the at least one scheduled event record to wireless devices within a broadcast range of the location transmitter, wherein the wireless device adds the scheduled event record to calendar information for the wireless device user.

18. The method of claim 17, wherein each scheduled event record includes information on an event sponsored by an event promoter.

19. The method of claim 18, wherein the event promoter pays a fee to have the transmitter system broadcast scheduled event records having information on events offered by the event promoter.

20. The method of claim 17, further comprising:
transmitting a list of scheduled events;
receiving, from the wireless device, user input indicating selection of at least one of the scheduled events on the list; and
transmitting the scheduled event record for each selected scheduled event to the wireless device from which the user input was received.

21. A wireless device providing information on a scheduled event in a personal information manager (PIM) application, wherein the wireless device is in wireless communication with a server including a calendar database for the user of the transmitting wireless device including scheduled event records, wherein the wireless device comprises:
means for receiving a code;
means for transmitting the received code to the server;
means for receiving from the server a scheduled event record including information on one scheduled event associated with the code; and
means for rendering calendar information at the wireless device including information on the scheduled event included in the scheduled event record.

22. The wireless device of claim 21, wherein the scheduled event record comprises a shadowed scheduled event record, wherein information on the shadowed scheduled event is displayed with the calendar information at the wireless device as a non-committed event.

23. A server system providing scheduled events for users of wireless devices in communication with the server system, wherein the wireless devices are capable of displaying calendar information on scheduled events, wherein the server system comprises:
means for receiving a code transmitted from the wireless device;
means for determining a scheduled event record corresponding to the received code; and
means for transmitting the determined scheduled event record to the wireless device that transmitted the code, wherein the wireless device is capable of rendering calendar information including information on the scheduled event included in the transmitted scheduled event record.

24. The server system of claim 23, wherein a plurality of codes are received from the wireless device and one determined scheduled event record for each code is transmitted to the wireless device transmitting the plurality of codes.

25. The server system of claim 23, wherein scheduled event records and codes are provided for different event promoters.

26. The server system of claim 25, further comprising:
means for charging a fee to the event promoter to include one scheduled event record in the data structure in order to make scheduled event records for the promoter available to wireless devices in response to transmissions of the code associated with the scheduled event record.

27. A wireless device for providing information on a scheduled event in a personal information manager (PIM) application, wherein the wireless device is capable of communicating with a transmitter system and a server, wherein the server maintains a calendar database for the user of the transmitting wireless device including scheduled event records, and wherein the wireless device comprises:
means for receiving a scheduled event record including information on a scheduled event transmitted from the transmitter system including at least one scheduled event record when the wireless device is within a broadcast range of the transmitter system;
means for rendering calendar information at the wireless device including information on the scheduled event included in the scheduled event record; and
means for transmitting the scheduled event record to the server, wherein the server stores the transmitted scheduled event record with the calendar database records for the user of the wireless device.

28. The wireless device of claim 27, further comprising:
means for receiving a list of scheduled events from the transmitter system;
means for receiving user input selecting at least one of the scheduled events on the list; and
means for transmitting information on the selected at least one scheduled event to the transmitter system, wherein receiving the scheduled event record further comprises receiving one scheduled event record for each selected scheduled event.

29. A transmitter for transmitting information on scheduled events, wherein the transmitter is capable of communicating with wireless devices, comprising:
means for providing information on at least on scheduled event record, wherein each scheduled event record includes information on a scheduled event; and
means for transmitting the at least one scheduled event record to wireless devices within a broadcast range of the location transmitter, wherein the wireless device adds the scheduled event record to calendar information for the wireless device user.

30. The transmitter of claim 29, wherein each scheduled event record includes information on an event sponsored by an event promoter.

31. The transmitter of claim 30, wherein the event promoter pays a fee to have the transmitter system broadcast scheduled event records having information on events offered by the event promoter.

32. The transmitter of claim 29, further comprising:
means for transmitting a list of scheduled events;
means for receiving, from the wireless device, user input indicating selection of at least one of the scheduled events on the list; and
means for transmitting the scheduled event record for each selected scheduled event to the wireless device from which the user input was received.

33. An article of manufacture including code implemented in a wireless device to provide information on a scheduled event in a personal information manager (PIM) application, wherein the code causes the wireless device to perform:
receiving a code;
transmitting the received code to a server including a calendar database for the user of the transmitting wireless device including scheduled event records;
receiving from the server a scheduled event record including information on one scheduled event associated with the code; and
rendering calendar information at the wireless device including information on the scheduled event included in the scheduled event record.

34. The article of manufacture of claim 33, wherein the code is entered via a user input mechanism on the wireless device.

35. The article of manufacture of claim 33, wherein the code is transmitted to the wireless device via a wireless transmission medium.

36. The article of manufacture of claim 35, wherein the code is transmitted to the wireless device, transmitted from the wireless device to the server, and rendered at the wireless device automatically without any intervening user action.

37. The article of manufacture of claim 33, wherein the scheduled event record comprises a shadowed scheduled event record, wherein information on the shadowed scheduled event is displayed with the calendar information at the wireless device as a non-committed event.

38. The article of manufacture of claim 33, wherein the code is transmitted to the server in response to user input at the wireless device.

39. The article of manufacture of claim 33, wherein receiving the code further comprises receiving a plurality of codes, wherein transmitting the code to the server comprises transmitting the plurality of codes, wherein receiving the scheduled event record from the server further comprises receiving one scheduled event record for each transmitted code, and wherein rendering calendar information at the wireless device including information on the scheduled event comprises rendering information on scheduled events for the received scheduled event records.

40. An article of manufacture including code implemented in a server to provide scheduled events for users of wireless devices, wherein the wireless devices are capable of displaying calendar information on scheduled events, and wherein the code causes the server to perform:
receiving a code transmitted from the wireless device;
determining a scheduled event record corresponding to the received code; and
transmitting the determined scheduled event record to the wireless device that transmitted the code, wherein the wireless device is capable of rendering calendar information including information on the scheduled event included in the transmitted scheduled event record.

41. The article of manufacture of claim 40, further comprising:
providing a data structure including a plurality of codes and associating with each code one scheduled event record, wherein determining the scheduled event record corresponding to the received code comprises searching the data structure for one code matching the received code transmitted from the wireless device and the associated scheduled event record.

42. The article of manufacture of claim 40, wherein a plurality of codes are received from the wireless device and one determined scheduled event record for each code is transmitted to the wireless device transmitting the plurality of codes.

43. The article of manufacture of claim 40, wherein scheduled event records and codes are provided for different event promoters.

44. The article of manufacture of claim 43, further comprising:
charging a fee to the event promoter to include one scheduled event record in the data structure in order to make scheduled event records for the promoter available to wireless devices in response to transmissions of the code associated with the scheduled event record.

45. An article of manufacture including code implemented in a wireless device to provide information on a scheduled event to a personal information manager (PIM) application, wherein the code causes the wireless device to perform:
receiving a scheduled event record including information on a scheduled event transmitted from a transmitter system including at least one scheduled event record when the wireless device is within a broadcast range of the transmitter system;
rendering calendar information at the wireless device including information on the scheduled event included in the scheduled event record; and
transmitting the scheduled event record to a server including a calendar database for the user of the transmitting wireless device including scheduled event records, wherein the server stores the transmitted scheduled event record with the calendar database records for the user of the wireless device.

46. The article of manufacture of claim 45, further comprising:
receiving user input to accept the scheduled event record, wherein information on the scheduled event in the scheduled event record is rendered with calendar information and wherein the scheduled event record is transmitted to the server to include in the calendar database for the user of the wireless device after receiving the user input to accept the scheduled event record.

47. The article of manufacture of claim 45, further comprising:
receiving a list of scheduled events from the transmitter system;
receiving user input selecting at least one of the scheduled events on the list; and
transmitting information on the selected at least one scheduled event to the transmitter system, wherein receiving the scheduled event record further comprises receiving one scheduled event record for each selected scheduled event.

48. The article of manufacture of claim 47, wherein rendering the calendar information at the wireless device further comprises rendering information on the scheduled event included in each received scheduled event record, and wherein transmitting the scheduled event to the server further comprises transmitting each scheduled event to the server.

49. An article of manufacture including code implemented in a transmitter for transmitting information on scheduled events, wherein the code causes the transmitter to perform:
providing information on at least on scheduled event record, wherein each scheduled event record includes information on a scheduled event; and
transmitting the at least one scheduled event record to wireless devices within a broadcast range of the location transmitter, wherein the wireless device adds the scheduled event record to calendar information for the wireless device user.

50. The article of manufacture of claim 49, wherein each scheduled event record includes information on an event sponsored by an event promoter.

51. The article of manufacture of claim 49, wherein the event promoter pays a fee to have the transmitter system broadcast scheduled event records having information on events offered by the event promoter.

52. The article of manufacture of claim 49, further comprising:
transmitting a list of scheduled events;
receiving, from the wireless device, user input indicating selection of at least one of the scheduled events on the list; and
transmitting the scheduled event record for each selected scheduled event to the wireless device from which the user input was received.
